(19) United States
(12) Patent Application Publication
(10) Pub. No.: US 2024/0407053 A1
(43) Pub. Date: Dec. 5, 2024

(54) A method of controlling a system for heating a process medium

(71) Applicant: Chromalox, Inc., Pittsburgh, PA (US)

(72) Inventors: Richard Trussler, Pittsburgh, PA (US); Mark Wheeler, Pittsburgh, PA (US)

(21) Appl. No.: 18/326,668

(22) Filed: May 31, 2023

(51) Int. Cl. H05B 1/02

(52) U.S. Cl. CPC H05B 1/0202; H05B 1/0244; H05B 2203/035

(57) ABSTRACT

The present disclosure relates to a method 200 of controlling a system 101, 102, 103 including a heating arrangement 130 for heating a process medium 140, a sensing arrangement 180, and a switching arrangement 120 configured to selectively couple a power supply 110 to the heating arrangement 130. The method 200 comprises: monitoring 210 a parameter of an electrical power provided by the power supply 110 using the sensing arrangement 180; comparing 230 the monitored parameter to a first threshold; and in response to a determination that the monitored parameter exceeds the first threshold: controlling 232 the switching arrangement 120 to decouple the power supply 110 from the heating arrangement 130.

### FIELD OF THE INVENTION

The present disclosure relates to a method of controlling a system for heating a process medium. It relates further to a system including a heating arrangement for heating a process medium.

### BACKGROUND TO THE INVENTION

In industrial processes, it may be necessary to heat a process medium such as oil, gas or another process fluid, or a solid process medium. In particular, heating of the process medium may be to maintain the process medium at the target temperature. In such industrial processes a system including an electric heating arrangement may be used for heating the process medium.

It is desirable to provide an improved method and system for heating a process medium which reduces a risk of failure of an electric heating arrangement used for heating the process medium while being able to maintain the process medium at or close to a target temperature or within a target temperature range.

### SUMMARY OF THE INVENTION

According to a first aspect there is provided a method of controlling a system including a heating arrangement for heating a process medium, a sensing arrangement, and a switching arrangement configured to selectively couple a power supply to the heating arrangement. The method comprises: monitoring a parameter of an electrical power provided by the power supply using the sensing arrangement; comparing the monitored parameter to a first threshold; and in response to a determination that the monitored parameter exceeds the first threshold: controlling the switching arrangement to decouple the power supply from the heating arrangement.

A rated voltage of the heating arrangement may be equal to or greater than 110 V. The rated voltage of the heating arrangement may be equal to or greater than 1 kV, or equal to or greater than 7.2 kV. The rated voltage of the heating arrangement may be between 110 V and 72.5 kV inclusive, between 1 kV and 72.5 kV inclusive, or between 7.2 kV and 72.5 kV inclusive.

It may be that the method further comprises: subsequent to controlling the switching arrangement to decouple the power supply from the heating arrangement: monitoring the parameter of the electrical power provided by the power supply; comparing the monitored parameter to the first threshold; and in response to a determination that the monitored parameter does not exceed the first threshold: controlling the switching arrangement to recouple the power supply to the heating arrangement.

The monitored parameter may be a voltage provided by the power supply, the voltage being an average voltage, a root mean square voltage, a peak voltage, a peak-to-peak voltage or an instantaneous voltage provided by the power supply. The monitored parameter may be a rate of change of a voltage provided by the power supply, the voltage being an average voltage, a root mean square voltage, a peak voltage or an instantaneous voltage provided by the power supply. The monitored parameter may be a rate of change of a current provided by the power supply, the current being an average current, a root mean square current, a peak current or an instantaneous current provided by the power supply.

It may be that the method further comprises: in response to a determination that the monitored parameter exceeds the first threshold: generating an alarm indicative of an anomaly in the electrical power provided by the power supply.

It may be that the method comprises: comparing the monitored parameter to a second threshold, the second threshold being lower than the first threshold; and in response to a determination that the monitored parameter exceeds the second threshold: storing information relating to the monitored parameter in a memory or transmitting information relating to the monitored parameter to an external system.

The or each threshold may be determined based on a signal received from an external system or a signal received from an interface to the system. The first threshold may be equal to or greater than 105% of a rated voltage of the heating arrangement. The second threshold may be equal to or greater than 102.5% of the rated voltage of the heating arrangement.

It may be that, when coupled to the heating arrangement by the switching arrangement, the power supply is configured to provide a periodic AC electrical power to the heating arrangement. The first threshold may be determined based on, or defined according to, a phase angle of the periodic AC electrical power provided by the power supply. The second threshold may be determined based on, or defined according to, the phase angle of the periodic AC electrical power provided by the power supply.

It may be that the method comprises: in response to a determination that the monitored parameter exceeds the first threshold: controlling the switching arrangement to decouple the power supply from the heating arrangement for at least a predetermined decoupling period. It may be that a duration of the predetermined decoupling period is no less than 1 second.

It may be that the method comprises: subsequent to controlling the switching arrangement to decouple the power supply from the heating arrangement: in response to a determination that the monitored parameter does not exceed the first threshold: controlling the switching arrangement to recouple the power supply to the heating arrangement after a predetermined recoupling delay period has elapsed since the determination that the monitored parameter did not exceed the first threshold.

It may be that the method comprises: subsequent to controlling the switching arrangement to decouple the power supply from the heating arrangement: in response to a determination that the monitored parameter does not exceed the first threshold: comparing the monitored parameter to the first threshold during a predetermined recoupling delay period, the predetermined recoupling delay period being measured since the determination that the monitored parameter did not exceed the first threshold was made; and in response to a determination that the monitored parameter did not exceed the first threshold during the predetermined recoupling delay period: controlling the switching arrangement to recouple the power supply to the heating arrangement after the predetermined recoupling delay period has elapsed.

It may be that, when coupled to the heating arrangement by the switching arrangement, the power supply is configured to provide a DC electrical power to the heating arrangement.

The switching arrangement may comprise at least one semiconductor switch. The at least one semiconductor switch may be selected from a group consisting of: a field-effect transistor, a gate turn-off thyristor, an integrated-gate bipolar transistor, an integrated gate-commutated thyristor, and an injection-enhanced gate transistor.

It may be that, when coupled to the heating arrangement by the switching arrangement, the power supply is configured to provide a polyphase periodic AC electrical power to the heating arrangement and the heating arrangement comprises a plurality of heating elements, each heating element being configured to receive a respective phase of the polyphase periodic AC electrical power from the power supply via the switching arrangement. It may also be that: monitoring the parameter of the electrical power provided by the power supply using the sensing arrangement includes monitoring the parameter of the electrical power on each phase of the polyphase periodic AC electrical power provided by the power supply; and comparing the monitored parameter to the first threshold includes comparing the monitored parameter on each phase of the polyphase periodic AC electrical power provided by the power supply to the first threshold.

According to a second aspect there is provided a system comprising: a heating arrangement for heating a process medium; a switching arrangement configured to selectively couple a power supply to the heating arrangement; a sensing arrangement; and a controller configured to control the system in accordance with the method of the first aspect. It may be that the switching arrangement comprises at least one semiconductor switch or at least one contactor. According to a third aspect, there is provided a data processing apparatus comprising a controller adapted to perform the method of the first aspect. According to a fourth aspect there is provided a machine-readable storage medium having stored thereon instructions which, when executed by a controller, cause the controller to carry out the method of the first aspect.

### BRIEF DESCRIPTION OF THE DRAWINGS

FIG. 1 shows, schematically, a first example system;

FIG. 2 shows, schematically, a second example system;

FIG. 3 shows, schematically, a third example system;

FIG. 4 is a flowchart which shows an example method of controlling a system;

FIG. 5 is an annotated graph which shows a profile of a supply of alternating current electrical power;

FIG. 6 is a highly schematic diagram of a data processing apparatus comprising a controller; and

FIG. 7 shows, symbolically, a machine-readable medium having stored thereon a software program which, when executed by a controller, causes the controller to perform the method of FIG. 4.

### DETAILED DESCRIPTION

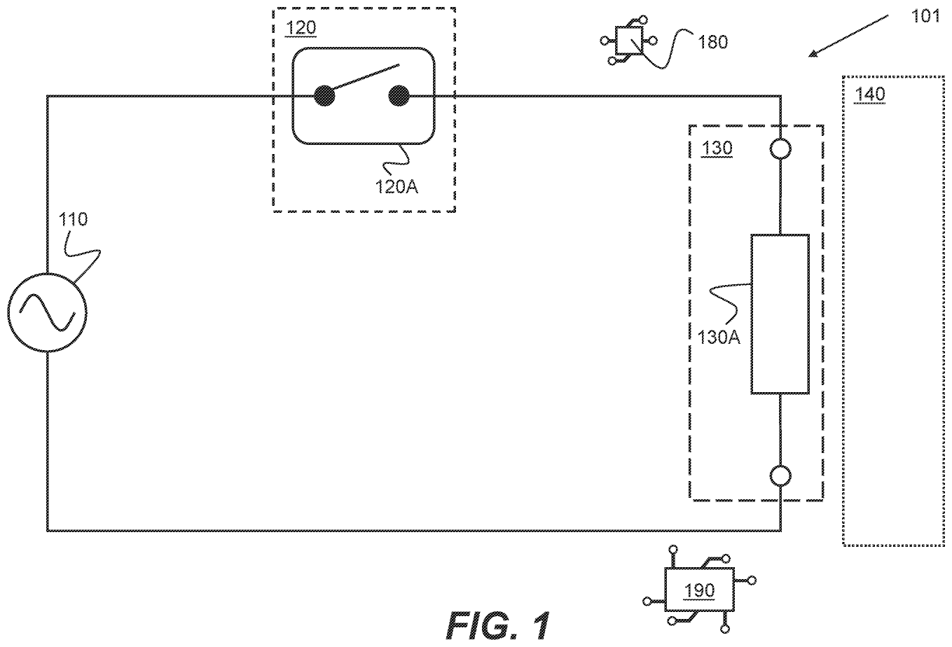

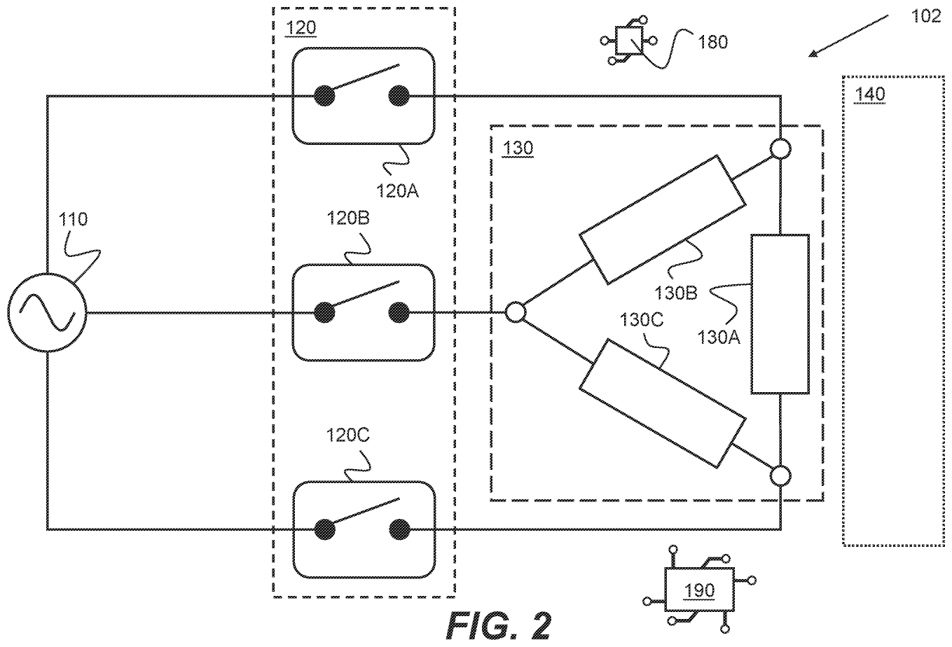

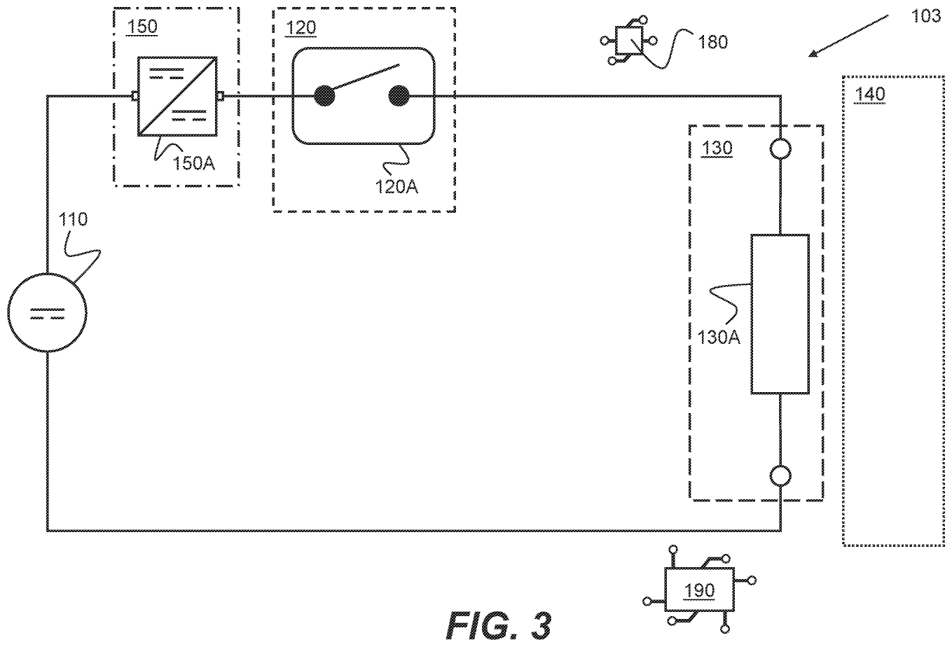

FIG. 1 shows a first example system 101 comprising a switching arrangement 120, a heating arrangement 130 for heating a process medium 140, a sensing arrangement 180 and a controller 190. FIG. 2 shows a second example system 102 which is generally similar to the first example system 101, with like reference signs indicating common or similar features. FIG. 3 shows a third example system 103 which is generally similar to the first example system 101, with like reference signs indicating common or similar features. The differences between each of the first example system 101, the second example system 102 and the third example system 103 are explained in detail below.

The switching arrangement 120 is generally configured to selectively couple a power supply 110 to the heating arrangement 130. When the power supply 110 is coupled to the heating arrangement 130 by the switching arrangement 120, the power supply 110 provides electrical power to the heating arrangement 130 for heating the process medium 140. The heating arrangement 130 is configured to convert electrical power supplied from the power supply 110 via the switching arrangement 120 into heat by means of an Ohmic heating process within a heating element of the heating arrangement 130. Heat is then transferred to the process medium 140 as a result of conduction, convection and/or radiation, as will be appreciated by those skilled in the art. When the power supply 110 is decoupled from (e.g. isolated from) the heating arrangement 130 by the switching arrangement 120, the power supply 110 does not provide electrical power to the heating arrangement 130.

To selectively couple the power supply 110 to the heating arrangement 130, the switching arrangement 120 optionally comprises at least one semiconductor switch. In use, the heating arrangement 130 may generally require the supply of a relatively large electric current to adequately heat the process medium 130. Consequently, other example systems in accordance with the present disclosure may make use of non-semiconductor switches for the purpose of selectively coupling and/or decoupling a power supply to a heating arrangement. For example, the switching arrangement 120 optionally comprises at least one mechanical or non-semiconductor switch 120A (e.g. at least one contactor 120A). It will be understood that mechanical or other non-semiconductor switches may generally have a higher rated current than semiconductor switches. However, use of at least one semiconductor switch 120A within the switching arrangement 120 advantageously enables selective coupling and/or decoupling of the power supply 110 and the heating arrangement 130 to be executed more rapidly compared to mechanical or non-semiconductor switches.

To this end, the at least one semiconductor switch 120A-120C may be, for example, a transistor or a thyristor. In particular, the or each semiconductor switch may be a field-effect transistor, a gate turn-off thyristor, integrated-gate bipolar transistor, an integrated gate-commutated thyristor, and/or an injection-enhanced gate transistor. Use of such types of semiconductor switches as a part of the switching arrangement 120 may provide more robust means for selectively coupling and/or decoupling the power supply 110 from the heating arrangement 130, which is associated with an extended lifetime of the system 101, 102, 103.

In both the first example electrical system 101 and the second example electrical system 102, the power supply 110 is an alternating current (AC) power supply 110. Accordingly, when the power supply 110 is coupled to the heating arrangement 130 by the switching arrangement 120, the power supply 110 provides a periodic AC electrical power to the heating arrangement 130.

In the first example electrical system 101 shown in FIG. 1, the power supply 110 is a monophase AC power supply 110. Therefore, when the power supply 110 is coupled to the heating arrangement 130 by the switching arrangement 120, the power supply 110 provides a monophase periodic AC electrical power to the heating arrangement 130. The switching arrangement 120 comprises a single semiconductor switch 120A, while the heating arrangement 130 comprises a single heating element 130A.

In the second example electrical system 102 shown in FIG. 2, the power supply 110 is a polyphase AC power supply 110. Therefore, when the power supply 110 is coupled to the heating arrangement 130 by the switching arrangement 120, the power supply 110 provides a polyphase periodic AC electrical power to the heating arrangement 130. The switching arrangement 120 comprises a plurality of semiconductor switches 120A-120C. The heating arrangement 130 comprises a plurality of heating elements 130A-130C. Although the power supply 110 is shown as being a three-phase AC power supply in the example of FIG. 2, those skilled in the art will appreciate that the principles described herein apply to similar systems provided with polyphase AC power supplies having any suitable number of phases. In the specific example of FIG. 2, the plurality of semiconductor switches includes a first semiconductor switch 120A, a second semiconductor switch 120B, and a third semiconductor switch 120C. Further, the plurality of heating elements 130A-130C includes a first heating element 130A, a second heating element 130B, and a third heating element 130C. Each heating element 130A-130C is configured to receive a respective phase of the polyphase electrical power provided by the power supply 110 via a corresponding semiconductor switch 120A-120C of the switching arrangement 120. Each phase of the polyphase electrical power is different to each other phase of the polyphase electrical power (that is, each phase of the polyphase electrical power has a different phase angle relative to each other phase of the polyphase electrical power). The supply of a respective phase of a polyphase electrical power to the heating arrangement 130 enables a smoother transfer of heat from the heating arrangement 130 to the process medium 140, because there is never any point in time, in use, when the applied voltage or the applied current within the heating arrangement 130 is zero.

In the second example electrical system 102 shown in FIG. 3, the power supply 110 is a direct current (DC) power supply 110. It follows that, when the power supply 110 is coupled to the heating arrangement 130 by the switching arrangement 120, the power supply 110 provides a DC electrical power to the heating arrangement 130. Additionally, the third example system 103 optionally comprises a DC-DC converter 150 configured to convert a DC electric current received from the power supply 110 having a first current magnitude into a DC electric current having a second current magnitude for supply to the heating arrangement 130 via the switching arrangement 120. The first current magnitude may generally be dissimilar to (i.e. different from) the second current magnitude. Accordingly, the DC-DC converter 150 is operable to control the magnitude of the DC electric current supplied to the heating arrangement 130 when the heating arrangement 130 is coupled to the power supply 110 by the switching arrangement 120. For this purpose, the DC-DC converter 150 may comprise a chopper converter 150A. This may ensure particularly efficient and effective conversion of the DC currents received from the power supply 110 and provided to the heating arrangement 130, respectively, by the DC-DC converter 150. The chopper converter 150A may be a step-up chopper or a step-down chopper converter.

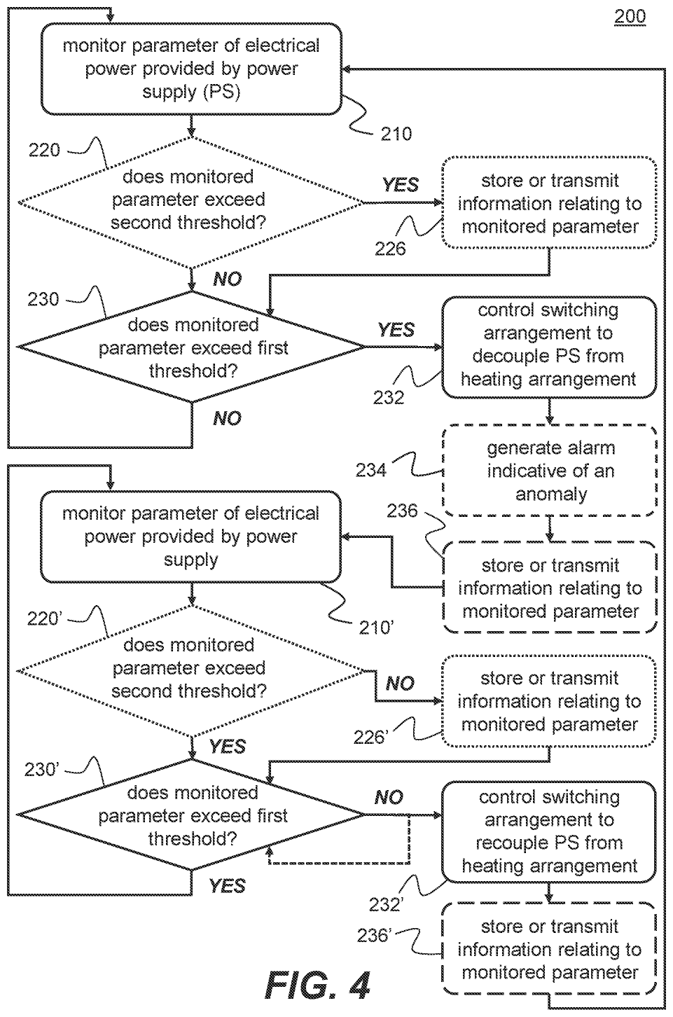

In each of the example systems 101, 102, 103, the sensing arrangement 180 is adapted to monitor an electrical power provided by the power supply 110. Specific types of circuitry suitable for use within the sensing arrangement 180 for the purpose of monitoring the electrical power provided by the power supply 110 will be known to those skilled in the art. In each of the example systems 101, 102, 103, the controller 190 is in data communication with the sensing arrangement 180 by means of a wired and/or a wireless data connection. The controller 190 is also configured to control the switching arrangement 120 in each of the example systems 101, 102, 103. In the third example system 103, the controller 190 is further configured to control the DC-DC converter 150. The controller 190 is configured to control the system 101, 102, 103 in accordance with the example method described below with reference to FIG. 4.

Further, in each of the example systems 101, 102, 103, the heating arrangement 130 may be configured as a low-voltage and/or a medium-voltage heating arrangement. If so, a rated voltage of the heating arrangement 130 may be equal to or greater than 110 V. Optionally, the rated voltage of the heating arrangement 130 may be equal to or greater than 1 kV and/or equal to or greater than 7.2 kV. Specifically, the rated voltage of the heating arrangement 130 may be between 110 V and 1 kV inclusive (when configured as a low-voltage heating arrangement 130) or between 1 kV and 7.2 kV to 72.5 kV inclusive (when configured as a medium-voltage heating arrangement 130). More generally, the rated voltage of the heating arrangement 130 may be between 110 V and 72.5 kV inclusive.

The power supply 110 may generally be configured to maintain the voltage and/or the current supplied to the switching arrangement 120 (and therefore to the heating arrangement 130) within predefined limits, which my be defined, for example, by relevant regulatory standards. However, the power supply 110 may be affected by a power swing event in which the voltage and/or the current supplied to the switching arrangement 120 (and therefore to the heating arrangement 130) strays outside of the predefined limits. A power swing event may be caused by, for instance, the coupling/decoupling of reactive loads (e.g. inductive and/or capacitive loads) to/from the power supply 110 or additional magnetic energy imparted to the power supply 110 by a solar flare. The power supply 110 may include a power regulator (e.g. a voltage regulator, such as a transformer with multiple secondary taps that can be switched using an electromechanical device) which is adapted to adjust the electrical power provided by the power supply 110 such that the voltage and/or the current supplied to the switching arrangement 120 is returned to a level within the predefined limits shortly after a power swing event has started.

A response period is a period of time which the power regulator takes to return the voltage and/or the current supplied to the switching arrangement 120 to within the predefined limits after the power swing event has started. The response period of the power regulator may be, for instance, of the order of seconds (e.g. greater than 1 second but less than 1 minute).

FIG. 4 is a flowchart which shows an example method 200 for controlling a system in accordance with any of the example systems 101, 102, 103 described above with reference to FIGS. 1-3.

The method 200 includes an action of monitoring a parameter of the electrical power provided by the power supply 110 using the sensing arrangement 180 (at block 210). The monitored parameter (that is, the parameter monitored at block 210) is an electrical parameter such as, for example, a voltage (e.g., an average voltage, a root mean square voltage, a peak voltage or an instantaneous voltage) provided by the power supply 110, a current (e.g., an average current, a root mean square current, a peak current or an instantaneous current) provided by the power supply 110, a power (e.g., an average power, a peak power or an instantaneous power) provided by the power supply 110, a rate of change of the voltage provided by the power supply 110, a rate of change of the current provided by the power supply 110, or a rate of change of the power provided by the power supply 110. For this purpose, the sensing arrangement 180 may comprise appropriate voltage monitoring apparatus and/or current monitoring apparatus, of a kind that will be familiar to those skilled in the art. For example, appropriate voltage monitoring apparatus may include a voltage transformer, a resistive or capacitive divider (with suitable detection circuitry), an electrostatic force detector, a voltage transducer or the like. If the power supply 110 is a polyphase AC power supply 110 as in the system 102 of FIG. 2, the action of monitoring the parameter of the electrical power provided by the power supply 110 using the sensing arrangement 180 (at block 210) may include monitoring the parameter of the electrical power on each phase of the polyphase periodic AC electrical power provided by the power supply 110 using the sensing arrangement 180.

The sensing arrangement 180 may be configured to sample the parameter of the electrical power (i.e., the voltage, current or power) provided by the power supply 110 at appropriate intervals (e.g., at an appropriate sampling frequency). The sampling frequency at which the parameter of the electrical power provided by the power supply 110 is sampled by the sensing arrangement 180 may be at least two times, at least five times, at least ten times, at least twenty times or at least one hundred times a frequency of the first harmonic of the periodic AC electrical power provided by the AC power supply 110. The sampled parameter across multiple intervals may be used for accurate calculation of the average, the root mean square and/or the peak parameter as applicable. In particular, if the power supply 110 is an AC power supply 110, the parameter of the electrical power provided by the power supply 110 may be sampled on multiple occasions during the time period of the periodic AC electrical power provided by the power supply 110. The average, the root mean square and/or the peak parameter may be calculated over a predetermined measurement period. If the power supply 110 is an AC power supply 110, the predetermined measurement period may be at least 50%, and optionally at least 100%, of the time period of the periodic AC electrical power provided by the power supply 110. The root mean square parameter may be determined based on the calculated peak parameter, for example by assuming that the periodic AC electrical power provided by the power supply 110 has a sinusoidal profile.

The method 200 further comprises an action of comparing the monitored parameter (that is, the parameter monitored at block 210) to a first threshold (at block 230). If the power supply 110 is a polyphase AC power supply 110 as in the system 102 of FIG. 2, the action of comparing the monitored parameter to the first threshold (at block 230) may include comparing the monitored parameter on each phase of the polyphase periodic AC electrical power provided by the power supply 110 to the first threshold.

The first threshold generally corresponds to a value of the monitored parameter which is indicative of a critical anomaly in the electrical power provided by the power supply 110. A critical anomaly in the electrical power provided by the power supply 110 is an anomaly which could lead to the power supply 110 being affected by a power swing event and which is likely to result in significant damage to the heating arrangement 130. Damage to the heating arrangement 130 may be caused by thermal effects (e.g. thermal stresses as a result of overvoltage), dielectric effects and/or chemical effects within the heating arrangement 130.

The first threshold may be predetermined based on a signal received from an external system or based on a signal received from an interface to the system 101, 102, 103. The external system may be, for instance, a centralised control system for an apparatus comprising the system 101, 102, 103. The interface may be a human-machine interface (HMI) which enables an operator to set and adjust the first threshold. In particular, the first threshold may be equal to or greater than 105% of a rated voltage of the heating arrangement 130. If the rated voltage of the heating arrangement 130 is equal to or greater than 110 V as discussed above, the first threshold may therefore be equal to or greater than 115.5 V. Similarly, if the rated voltage of the heating arrangement 130 is equal to or greater than 1 kV as discussed above, the first threshold may therefore be equal to or greater than 1.05 kV. Further, if the rated voltage of the heating arrangement 130 is equal to or greater than 7.2 kV as discussed above, the first threshold may therefore be equal to or greater than 7.56 kV.

In response to a determination that the monitored parameter exceeds the first threshold, the method 200 proceeds to an action of controlling the switching arrangement 120 to decouple the power supply 110 from the heating arrangement 130 (at block 232). The method 200 may then generate an alarm (at block 234, as shown in FIG. 4), and/or store information relating to the monitored parameter in a memory and/or transmit information relating to the monitored parameter to an external system (at block 236) before or while proceeding to a further action of monitoring the parameter of the electrical power provided by the power supply 110 using the sensing arrangement 180 (at block 210′, as described in further detail below). Alternatively, the method 200 may proceed directly to block 210′ without generating an alarm or storing/transmitting information relating to the monitored parameter.

Because the monitored parameter exceeding the first threshold is indicative of a critical anomaly in the electrical power provided by the power supply 110, the alarm generated (at block 234) may be indicative of a fault associated with the power supply 110. The alarm may warn an operator of the system 101, 102, 103 of the fault associated with the power supply 110 and thereby enable the operator to carry out diagnostic tests on the power supply 110 and/or attempt to address the fault associated with the power supply 110. Generating the alarm (at block 234) may, for example, involve energising an alarm circuit provided to the system 101, 102, 103.

With respect to the action represented by block 236, the stored and/or transmitted information relating to the monitored parameter may include a time at which the monitored parameter was determined to exceed the first threshold and, optionally, a value of the monitored parameter at the time at which the monitored parameter was determined to exceed the first threshold.

In response to a determination that the monitored parameter does not exceed the first threshold, the method 200 returns to block 210 to continue monitoring the parameter of the electrical power provided by the power supply 110 using the sensing arrangement 180 without decoupling the power supply 110 from the heating arrangement 130.

The method 200 may further comprise an action of comparing the monitored parameter to a second threshold (at block 220). The second threshold generally corresponds to a value of the monitored parameter which is indicative of a non-critical anomaly in the electrical power provided by the power supply 110. A non-critical anomaly in the electrical power provided by the power supply 110 is an anomaly which could lead to the power supply 110 being affected by a power swing event but which is not likely to result in significant damage to the heating arrangement 130. Consequently, the second threshold is lower than the first threshold.

In a similar way to the first threshold, the second threshold may be predetermined based on a signal received from an external system or based on a signal received from an interface to the system 101, 102, 103. In particular, the second threshold may be equal to or greater than 102.5% of a rated voltage of the heating arrangement 130. If the rated voltage of the heating arrangement 130 is equal to or greater than 110 V as discussed above, the second threshold may therefore be equal to or greater than 112.75 V.

Similarly, if the rated voltage of the heating arrangement 130 is equal to or greater than 1 kV as discussed above, the second threshold may therefore be equal to or greater than 1.025 kV. Further, if the rated voltage of the heating arrangement 130 is equal to or greater than 7.2 kV as discussed above, the second threshold may therefore be equal to or greater than 7.38 kV.

In response to a determination that the monitored parameter exceeds the second threshold, the method 200 proceeds to an action of storing information relating to the monitored parameter in a memory and/or transmitting information relating to the monitored parameter to an external system (at block 226). The information relating to the monitored parameter may include a time at which the monitored parameter was determined to exceed the second threshold and, optionally, a value of the monitored parameter at the time at which the monitored parameter was determined to exceed the second threshold. After storing information relating to the monitored parameter in a memory and/or transmitting information relating to the monitored parameter to an external system (at block 226), the method 200 continues to the action of comparing the monitored parameter to the first threshold (at block 230).

Conversely, in response to a determination that the monitored parameter does not exceed the second threshold, the method 200 continues to the action of comparing the monitored parameter to the first threshold (at block 230) without storing or recording information relating to the monitored parameter, as shown in FIG. 4. The method 200 then continues from block 230 as described herein.

Turning now to the further action represented by block 210′, the further action of monitoring the parameter of the electrical power provided by the power supply 110 using the sensing arrangement 180 (at block 210′) is generally similar to the action of monitoring the parameter of the electrical power provided by the power supply 110 using the sensing arrangement 180 (at block 210) described above. Like the parameter monitored at block 210, the parameter monitored at block 210′ may be, for instance, a voltage provided by the power supply 110, a current provided by the power supply 110, a power provided by the power supply 110, a rate of change of the voltage provided by the power supply 110, a rate of change of the current provided by the power supply 110, or a rate of change of the power provided by the power supply 110. In some examples, the parameter monitored at block 210′ is the same as the parameter monitored at block 210. However, in other examples, the parameter monitored at block 210′ is different to the parameter monitored at block 210. The method 200 also comprises a further action of comparing the monitored parameter (that is, the parameter monitored at block 210′) to the first threshold (at block 230′).

However, in response to a determination (in block 230′) that the monitored parameter does not exceed the first threshold (that is, the monitored parameter no longer exceeds the first threshold), the method 200 proceeds to an action of controlling the switching arrangement 120 to recouple the power supply 110 to the heating arrangement 130 (at block 232′). The method 200 may then store information relating to the monitored parameter in a memory and/or transmit information relating to the monitored parameter to an external system (at block 236′) before or while returning to the action of monitoring the parameter of the electrical power provided by the power supply 110 using the sensing arrangement 180 (at block 210). Alternatively, the method 200 may proceed directly to block 210 without storing/transmitting information relating to the monitored parameter. The method 200 then continues from block 210 as described herein.

With respect to the action represented by block 236′, the stored and/or transmitted information relating to the monitored parameter may include a time at which the monitored parameter was determined to no longer exceed the first threshold and, optionally, a value of the monitored parameter at the time at which the monitored parameter was determined to no longer exceed the first threshold.

In response to a determination (in block 230′) that the monitored parameter exceeds the first threshold (that is, the monitored parameter still exceeds the first threshold), the method 200 returns directly to the further action of monitoring the parameter of the electrical power provided by the power supply 110 using the sensing arrangement 180 (at block 210′) without recoupling the power supply 110 from the heating arrangement 130. The method 200 then continues from block 210′ as described herein.

The method 200 may also comprise a further action of comparing the monitored parameter to the second threshold (at block 220′). The further action of comparing the monitored parameter to the second threshold (at block 220′) is generally similar to the action of comparing the monitored parameter to the second threshold (at block 220) described above.

In response to a determination (in block 220′) that the monitored parameter does not exceed the second threshold (that is, the monitored parameter no longer exceeds the second threshold), the method 200 proceeds to an action of storing information relating to the monitored parameter in a memory and/or transmitting information relating to the monitored parameter to an external system (at block 226′). The information relating to the monitored parameter may include a time at which the monitored parameter was determined to no longer exceed the second threshold and, optionally, a value of the monitored parameter at the time at which the monitored parameter was determined to no longer exceed the second threshold. After storing information relating to the monitored parameter in a memory and/or transmitting information relating to the monitored parameter to an external system (at block 226′), the method 200 continues to the further action of comparing the monitored parameter to the first threshold (at block 230′).

Conversely, in response to a determination (in block 220′) that the monitored parameter exceeds the second threshold (that is, the monitored parameter still exceeds the second threshold), the method 200 continues to the action of comparing the monitored parameter to the first threshold (at block 230′), as shown in FIG. 4. The method 200 then continues from block 230′ as described herein.

As discussed above, when the power supply 110 is decoupled from the heating arrangement 130 by the switching arrangement 120, the power supply 110 does not provide electrical power to the heating arrangement 130 and therefore the heating arrangement 130 does not provide heating to the process medium 140. A time period for which the power supply 110 is decoupled from the heating arrangement 130 and the heating arrangement 130 does not provide heating to the process medium 140 may be referred to as a downtime of the heating arrangement 130.

In some systems, a heating arrangement may be designed to withstand large voltage and/or the current variations in the electrical power supplied by the power supply during a power swing event so that electrical power is continually provided to the heating arrangement by the power supply throughout the power swing event. As a result, the process medium is continually heated throughout the power swing event with a view to ensuring that the process medium is maintained at or close to a target temperature or within a target temperature range despite the occurrence of the power swing event.

In contrast, in methods and systems in accordance with the present disclosure, the power supply 110 is decoupled from the heating arrangement 130 when the monitored parameter rises above the first threshold and is recoupled to the heating arrangement 130 when the monitored parameter falls below the first threshold. Therefore, the heating arrangement 130 is decoupled from the power supply 110 while the monitored parameter is above the first threshold and so the heating arrangement 130 does not provide heating to the process medium 140 while the monitored parameter is above the first threshold.

Accordingly, the heating arrangement 130 is protected from damage due to thermal effects (e.g. thermal stresses as a result of overvoltage), dielectric effects and/or chemical effects if the heating arrangement 130 received the electrical power from the power supply 110 while the monitored parameter is above the first threshold. Therefore, the heating arrangement 130 need not be designed to withstand large voltage and/or current variations in the electrical power supplied by the power supply 110. As a result, a complexity, a weight and/or a material usage of the heating arrangement 130 may be reduced.

In addition, it has been found that the downtime of the heating arrangement 130 which is brought about as a result of performance of methods in accordance with the present disclosure is typically short enough that there is no significant detrimental effect on the temperature of the process medium 140, and therefore the ability of the method 200 to maintain the process medium 140 at or close to a target temperature or within a target temperature range is not significantly reduced by the downtime of the heating arrangement 130.

The information relating to the monitored parameter which is stored and/or transmitted as a result of the action(s) represented by blocks 226, 226′, 236 and 236′ may be used to analyse the quality of the electrical power supplied by the power supply 110. For example, if the monitored parameter frequently exceeds the first threshold and/or frequently exceeds the first threshold for an extended period of time, the quality of the electrical power supplied by the power supply 110 may be considered to be low. If so, attempts may be made to improve the quality of the power supply 110 and therefore reduce a frequency with which the monitored parameter exceeds the first threshold.

Accordingly, the frequency with which the switching arrangement 120 is controlled to decouple the power supply 110 from the heating arrangement 130 may be reduced, which in turn may enable the process medium 140 to be better maintained at the target temperature as a consequence of reduced downtime of the heating arrangement 130.

If the monitored parameter is a rate of change of the voltage provided by the power supply 110, a rate of change of the current provided by the power supply 110, or a rate of change of the power provided by the power supply 110, the method 200 may result in the heating arrangement 130 being quickly decoupled from the power supply 100 following the start of a power swing event. This is associated with enhanced protection of the heating arrangement 130 from damage due to thermal effects. However, this may result in more frequent decoupling of the heating arrangement 130 from the power supply 110 in use, which may reduce the ability of the method 200 to maintain the process medium 140 at or close to the target temperature or within the target temperature range. Moreover, if the monitored parameter is the instantaneous parameter of the electrical power provided by the power supply 110 (i.e., the instantaneous voltage, current or power) or the rate of change of the instantaneous parameter of the electrical power provided by the power supply 110 (i.e., the rate of change of the instantaneous voltage, current or power), the method 200 may result in decoupling of the heating arrangement 130 from the power supply 110 when the electrical power provided by the power supply 110 includes undesirable frequency components (e.g., if the power supply 110 is an AC power supply 110, higher order harmonics such as the third, fifth and seventh harmonics) which may be liable to cause damage to the heating arrangement 130 due to excessive heating over a relatively short period of time. In contrast, if the monitored parameter were, for instance, the average parameter, the root mean square parameter or the peak parameter of the electrical power provided by the power supply 110, the electrical power provided by the power supply 110 including such frequency components may not result in the heating arrangement 130 being decoupled from the power supply 110 (because using the average parameter, the root mean square parameter or the peak parameter may not adequately capture such frequency components). In this way, the heating arrangement 130 may be further protected from a risk of damage.

In the example of FIG. 4, block 220 is shown as being above block 230 and the actions represented by blocks 220 and 230 are generally described as being executed sequentially. Similarly, block 220′ is shown as being above block 230; in the example of FIG. 4 and the actions represented by blocks 220′ and 230′ are generally described as being executed sequentially. However, this disclosure anticipates that the actions represented by blocks 220 and 230 may be executed concurrently, as will be appreciated by those skilled in the art.

The switching arrangement 120 may be controlled (at block 232) to decouple the power supply 110 from the heating arrangement 130 for at least a predetermined decoupling period. The predetermined decoupling period may be adjustable via a user-interface or a machine-interface to the system 100 (e.g., to the controller 190). The predetermined decoupling period defines a minimum duration for which the supply of electrical power to the heating arrangement 130 is interrupted and therefore a minimum duration for which heating of the process medium 140 by the heating arrangement 130 is interrupted. Generally, the duration of the predetermined decoupling period may be no less than the response period of a power regulator described above. Accordingly, the duration of the predetermined decoupling period may generally be no less than 1 second. This ensures that the power supply 110 cannot be recoupled to the heating arrangement 130 (at block 232′) until the power regulator has had sufficient time to return the voltage and/or the current supplied to the switching arrangement 120 to a level within the relevant predefined limits after a power swing event has started (as indicated by the monitored parameter exceeding the first threshold). After the predetermined decoupling period has elapsed, the method 200 may continue from the action of decoupling the power supply 110 from the heating arrangement 130 as described herein, such as to the further action of monitoring the parameter of the electrical power provided by the power supply 110 using the sensing arrangement 180 (at block 210′). If the electrical power provided by the power supply 110 is subject to significant recurring/oscillatory power swings in use, this may enable the heating arrangement 130 to be relatively well protected from damage while still facilitating the process medium being maintained at or close to the target temperature or within the target temperature range.

Alternatively, in response to a determination (in block 230′) that the monitored parameter does not exceed the first threshold (that is, the monitored parameter no longer exceeds the first threshold), the method 200 may not directly proceed to the action of controlling the switching arrangement 120 to recouple the power supply 110 to the heating arrangement 130 (at block 232′). Instead, the method 200 may repeatedly compare the monitored parameter to the first threshold (e.g. in a loop with respect to block 230′) until the end of a predetermined recoupling delay period since the determination that the monitored parameter no longer exceeds the first threshold (at block 230′) was first made. If no determination that the monitored parameter exceeds the first threshold is made prior to the end of the predetermined recoupling delay period, the method proceeds to the action of controlling the switching arrangement 120 to recouple the power supply 110 to the heating arrangement 130 (at block 232′). Otherwise, if a determined that the monitored parameter exceeds the first threshold during the predetermined recoupling delay period, the method 200 may return to the further action of monitoring the parameter of the electrical power provided by the power supply 110 (at block 210′) and continuing thereafter as described herein. In this way, the switching arrangement 120 may be controlled (at block 232′) to recouple the power supply 110 to the heating arrangement 130 only after the predetermined recoupling delay period has elapsed since the determination that the monitored parameter no longer exceeds the first threshold (at block 230′) was made. The predetermined recoupling delay period may be adjustable via a user-interface or a machine-interface to the system 100 (e.g., to the controller 190).

The predetermined recoupling delay period may be selected and/or adjusted so as to reduce a probability that a transient event affecting the power supply 110 (e.g., an event in which a relatively large inductive/capacitive load is disconnected from the power supply 110) which may have caused the monitored parameter to exceed the first threshold is still in progress when the heating arrangement 130 is recoupled to the power supply 110 (at block 232′).

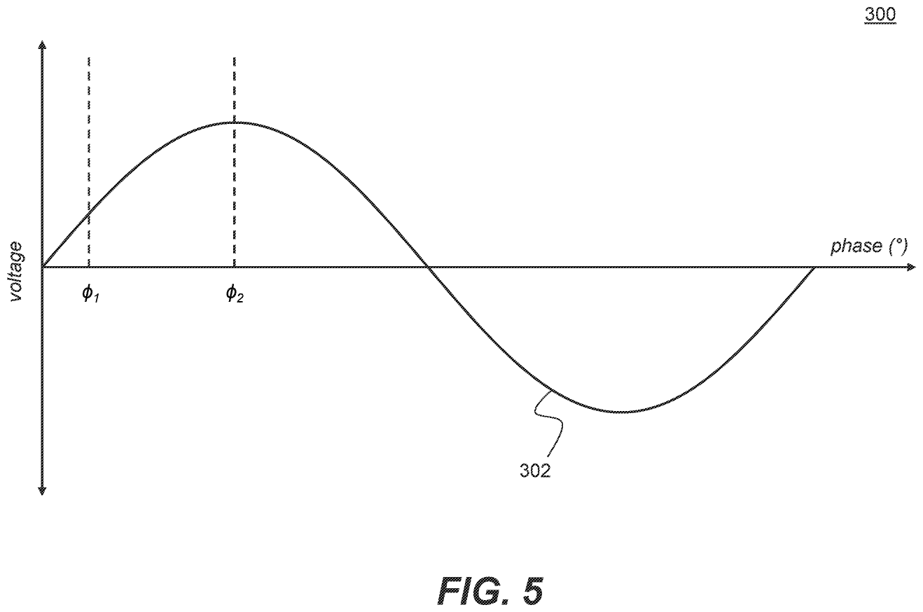

Specific example implementations of the method 200 for use in the context of a system 101, 102 comprising an AC power supply 110 are explained below with reference to FIG. 5, which is an annotated graph 300 which shows a simplified profile 302 of the voltage of one phase of the periodic AC electrical power provided by the AC power supply 110 on the y-axis against the phase (in degrees, °) of the periodic AC electrical power on the x-axis. The simplified profile 302 shown in FIG. 5 is intended to aid understanding of the method 200 described herein, and is not intended to closely correspond to a true profile of one phase AC electrical power provided by the AC power supply 110 in typical operation. For the purpose of the following explanation, FIG. 5 also shows a first phase angle ϕ₁ of the periodic AC electrical power 302 and a second phase angle ϕ₂ of the periodic AC electrical power 302.

If the power supply 110 is an AC power supply 110, the first threshold and/or the second threshold may be defined according to a phase angle of the periodic AC electrical power provided by the AC power supply 110. For the purpose of the following explanation, FIG. 5 also shows a first phase angle ϕ₁ of the periodic AC electrical power 302 and a second phase angle ϕ₂ of the periodic AC electrical power 302. At the first phase angle ϕ₁, the voltage gradient (that is, the first derivative of the voltage with respect to phase or time) of the periodic AC electrical power 302 is positive, whereas at the second phase angle ϕ₂, the voltage gradient of the periodic AC electrical power 302 is approximately zero. Further, the voltage magnitude of the periodic AC electrical power 302 at the second phase angle ϕ₂ is greater than the voltage magnitude of the periodic AC electrical power 302 at the first phase angle ϕ₁.

As an example, if the monitored parameter is a rate of change of a voltage provided by the power supply 110 (e.g. a voltage gradient), the first threshold and/or the second threshold may be defined as being greater at the first phase angle ϕ₁ compared to at the second phase angle ϕ₂. As another example, if the monitored parameter is a voltage provided by the power supply 110 (e.g. a voltage magnitude), the first threshold and/or the second threshold may be defined as being greater at the second phase angle ϕ₂ compared to at the first phase angle ϕ₁.

Defining the first threshold and/or the second threshold according to the phase angle of the periodic AC electrical power provided by the AC power supply 110 may be advantageously used when the monitored parameter is the instantaneous parameter of the electrical power provided by the power supply 110 (i.e., the instantaneous voltage, current or power) or the rate of change of the instantaneous parameter of the electrical power provided by the power supply 110 (i.e., rate of change of the instantaneous voltage, current or power) when the electrical power provided by the power supply 110 includes undesirable frequency components, as discussed above.

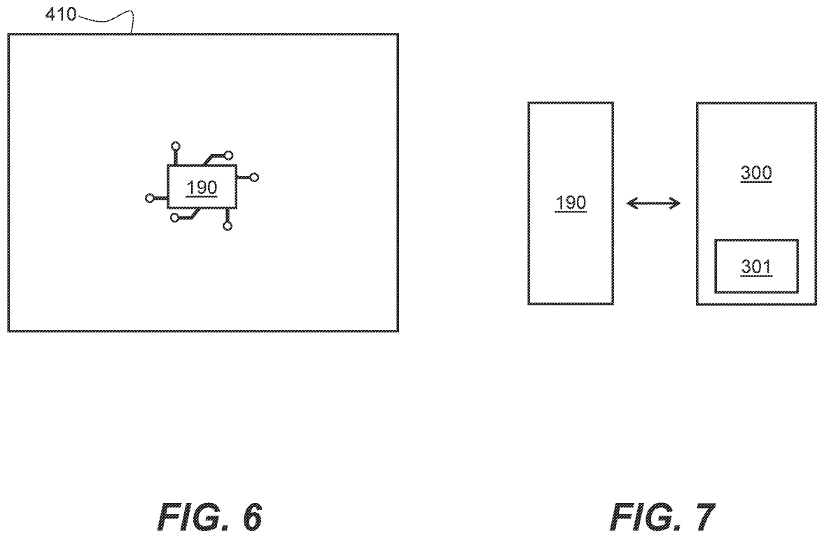

FIG. 6 highly schematically shows a data processing apparatus 410 comprising a controller 190 adapted to perform the method(s) 200, 200′ described above with reference to FIG. 4. The controller 190 may have any of the features of the controller 190 described above with respect to FIGS. 1-3. FIG. 7 highly schematically shows a machine-readable medium 300 having stored thereon a software program 301 comprising instructions which, when executed by a controller 190 (e.g. the controller 190 provided to the example systems 101, 102, 103 described above with reference to FIGS. 1-3), cause the controller 190 to execute the method(s) 200, 200′ described above with reference to FIG. 4.

The controller 190 described herein may comprise a processor. The controller or processor may comprise: at least one application specific integrated circuit (ASIC); and/or at least one field programmable gate array (FPGA); and/or single or multi-processor architectures; and/or sequential (Von Neumann)/parallel architectures; and/or at least one programmable logic controllers (PLCs); and/or at least one microprocessor; and/or at least one microcontroller; and/or a central processing unit (CPU), to the stated functions for which the controller or processor is configured.

Except where mutually exclusive, a feature described in relation to any one of the above aspects may be applied mutatis mutandis to any other aspect. Furthermore, except where mutually exclusive, any feature described herein may be applied to any aspect and/or combined with any other feature described herein.

1. A method of controlling a system including a heating arrangement for heating a process medium, a sensing arrangement, and a switching arrangement configured to selectively couple a power supply to the heating arrangement, the method comprising:
monitoring a parameter of an electrical power provided by the power supply using the sensing arrangement;
comparing the monitored parameter to a first threshold; and
in response to a determination that the monitored parameter exceeds the first threshold:
controlling the switching arrangement to decouple the power supply from the heating arrangement.

2. The method of claim 1, wherein a rated voltage of the heating arrangement is equal to or greater than 110 V.

3. The method of claim 1, wherein the method further comprises:
subsequent to controlling the switching arrangement to decouple the power supply from the heating arrangement:
monitoring the parameter of the electrical power provided by the power supply;
comparing the monitored parameter to the first threshold; and
in response to a determination that the monitored parameter does not exceed the first threshold:
controlling the switching arrangement to recouple the power supply to the heating arrangement.

4. The method of claim 1, wherein the monitored parameter is a voltage provided by the power supply, the voltage being an average voltage, a root mean square voltage, a peak voltage, a peak-to-peak voltage or an instantaneous voltage provided by the power supply.

5. The method of claim 1, wherein the monitored parameter is:
a rate of change of a voltage provided by the power supply, the voltage being an average voltage, a root mean square voltage, a peak voltage or an instantaneous voltage provided by the power supply; or
a rate of change of a current provided by the power supply, the current being an average current, a root mean square current, a peak current or an instantaneous current provided by the power supply.

6. The method of claim 1, wherein the method further comprises:
in response to a determination that the monitored parameter exceeds the first threshold:
generating an alarm indicative of an anomaly in the electrical power provided by the power supply.

7. The method of claim 1, wherein the method comprises:
comparing the monitored parameter to a second threshold, the second threshold being lower than the first threshold; and
in response to a determination that the monitored parameter exceeds the second threshold:
storing information relating to the monitored parameter in a memory or transmitting information relating to the monitored parameter to an external system.

8. The method of claim 1, wherein the first threshold is equal to or greater than 105% of a rated voltage of the heating arrangement.

9. The method of claim 1, wherein, when coupled to the heating arrangement by the switching arrangement, the power supply is configured to provide a periodic AC electrical power to the heating arrangement.

10. The method of claim 9, wherein the first threshold is defined according to a phase angle of the periodic AC electrical power provided by the power supply.

11. The method of claim 1, wherein the method comprises:
in response to a determination that the monitored parameter exceeds the first threshold:
controlling the switching arrangement to decouple the power supply from the heating arrangement for at least a predetermined decoupling period.

12. The method of claim 3, wherein the method comprises:
subsequent to controlling the switching arrangement to decouple the power supply from the heating arrangement:
in response to a determination that the monitored parameter does not exceed the first threshold:
controlling the switching arrangement to recouple the power supply to the heating arrangement after a predetermined recoupling delay period has elapsed since the determination that the monitored parameter did not exceed the first threshold.

13. The method of claim 1, wherein, when coupled to the heating arrangement by the switching arrangement, the power supply is configured to provide a DC electrical power to the heating arrangement.

14. The method of claim 1, wherein the switching arrangement comprises at least one semiconductor switch.

15. The method of claim 14, wherein the at least one semiconductor switch is selected from a group consisting of: a field-effect transistor, a gate turn-off thyristor, an integrated-gate bipolar transistor, an integrated gate-commutated thyristor, and an injection-enhanced gate transistor.

16. The method of claim 1, wherein, when coupled to the heating arrangement by the switching arrangement, the power supply is configured to provide a polyphase periodic AC electrical power to the heating arrangement and the heating arrangement comprises a plurality of heating elements, each heating element being configured to receive a respective phase of the polyphase periodic AC electrical power from the power supply via the switching arrangement.

17. The method of claim 16, wherein:
monitoring the parameter of the electrical power provided by the power supply using the sensing arrangement includes monitoring the parameter of the electrical power on each phase of the polyphase periodic AC electrical power provided by the power supply; and
comparing the monitored parameter to the first threshold includes comparing the monitored parameter on each phase of the polyphase periodic AC electrical power provided by the power supply to the first threshold.

18. A system comprising:
a heating arrangement for heating a process medium;
a switching arrangement configured to selectively couple a power supply to the heating arrangement;
a sensing arrangement; and
a controller configured to control the system in accordance with the method of claim 1.

19. A data processing apparatus comprising a controller adapted to perform the method of claim 1.

20. A machine-readable storage medium having stored thereon instructions which, when executed by a controller, cause the controller to carry out the method of claim 1.
